(19) United States
(12) Patent Application Publication
(10) Pub. No.: US 2009/0235641 A1
(43) Pub. Date: Sep. 24, 2009

(54) T-Jet

(76) Inventor: Kevin Marion Brown, N Charleston, SC (US)

Correspondence Address: Kevin Marion Brown, 1908 Boxwood Ave, N Charleston, SC, 29405, US

(21) Appl. No.: 12/001,965

(22) Filed: Mar. 20, 2008

(51) Int. Cl. F02K 1/38

(52) U.S. Cl. 60/262; 244/1 R

(57) ABSTRACT

The following is the design of a personal, strap-on the back flight device. It is my version of an air breathing jetpack; it is designed to give an individual pilot vertical take-off, horizontal flight and vertical landing capabilities.

### SUMMARY

This device is founded upon the idea of redesigning the turbofan engine around the human body. My vehicles structure is built primarily of aluminium and will weight in at between 85 and 110 lbs total including fuel. The use of two compressor assembles on one central horizontal shaft allows for double the air flow using the same fuel necessary to turn the shaft. The horizontal shaft prevents the device from being turned by engine toque because the majority of the body as well as the device is hung below the lower half of the horizontal section. It also eliminates the need for counter-rotating blades. The turbine housing is in the center of the horizontal shaft, in the center of the horizontal section. The turbine is cooled from both sides by the twin compressor's airflow.

It is shaped to be part of the structure designed to turn the air from the compressors the 90 degrees needed to direct the airflow into the combustion chambers and out the bottom of the vertical housing. My device uses the compressed air as well as the burnt fuel-air mixture for vertical thust. my vehicle is designed to lift on the thrust from three points.

1. Air flowing out the combustion chamber housing (the vertical unit).

2. The exhaust tubing pointing downward.

### INDEX

### Pg

11. Horizontal section

12. Vertical section (upper half)

13 Vertical section (full view)

14. Exhaust Turbine (internal front view)

15. Combustion chamber assembly (top and internal side view)

16. Exhaust Turbine (side view)

17. Exhaust Turbine (front view)

18. Rear view, full assembly with internal view

19. Manifold (rear view w/ellbows)

20. Manifold (showing range of motion)

21. Elbows (showing range of motion)

22. Directional Controls w/adjustments

23. Exhaust tubing tilt adjustment

24. Manifold tilt control using hand controls.

25. Chute deployment cylinder

25B. Mainchute line to frame w\control lines to manifold.

26. Rear view (external, showing radar transmitter\reciever)

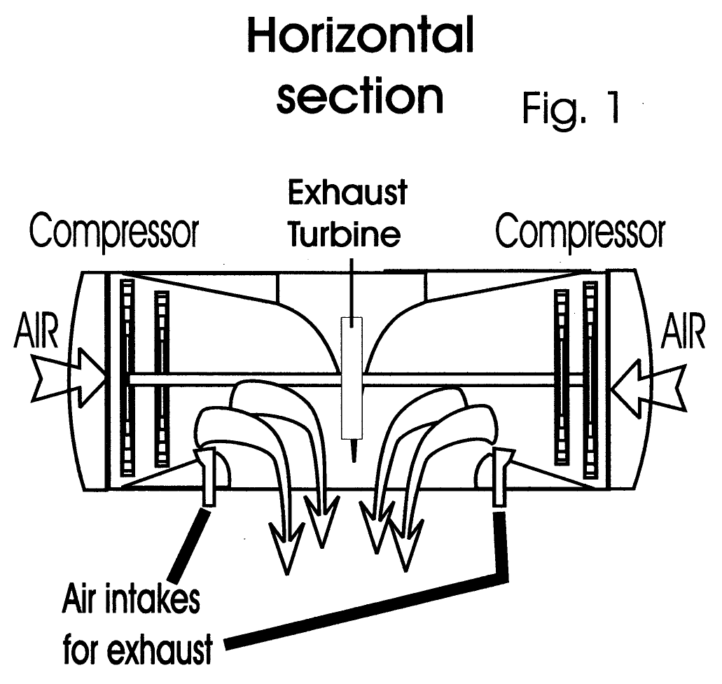

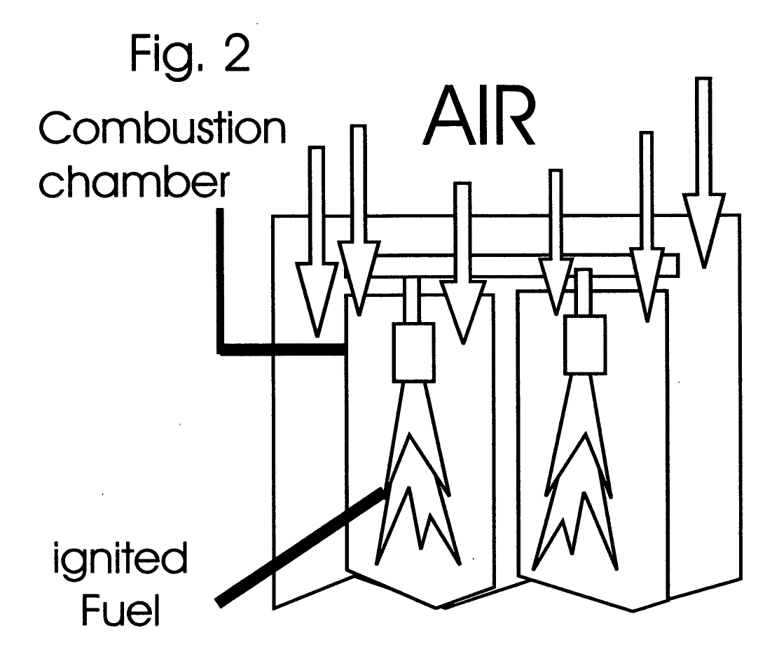

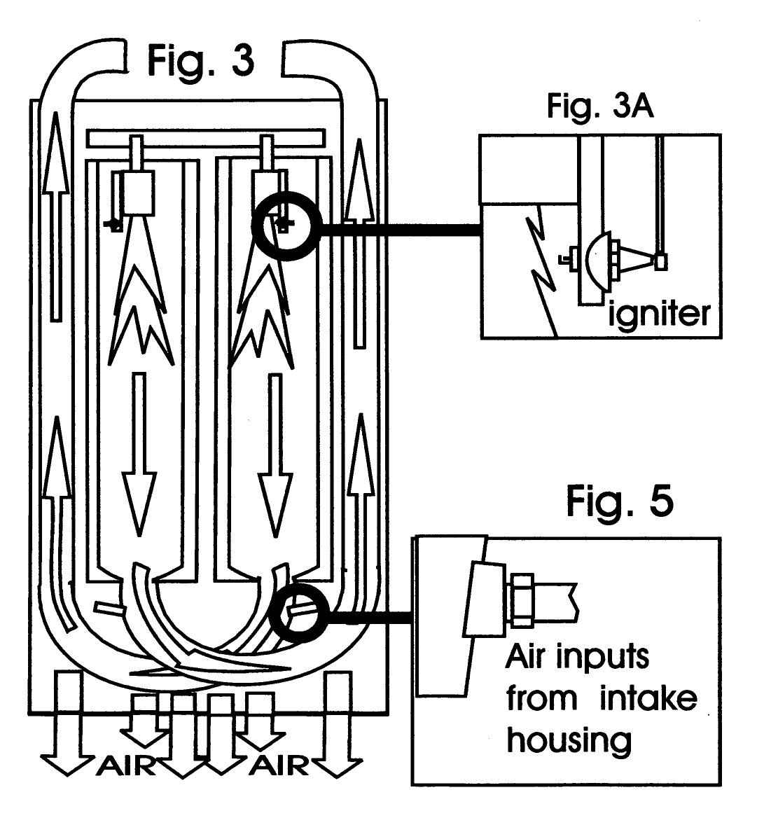

Air is pulled into the unit by the rotors of one or more small compressors at the opposite ends of a common horizontal shaft in the intake housing (see FIG. 1, page 11) and forced down though ninty-degrees into the vertical unit (see FIG. 2, page 12).

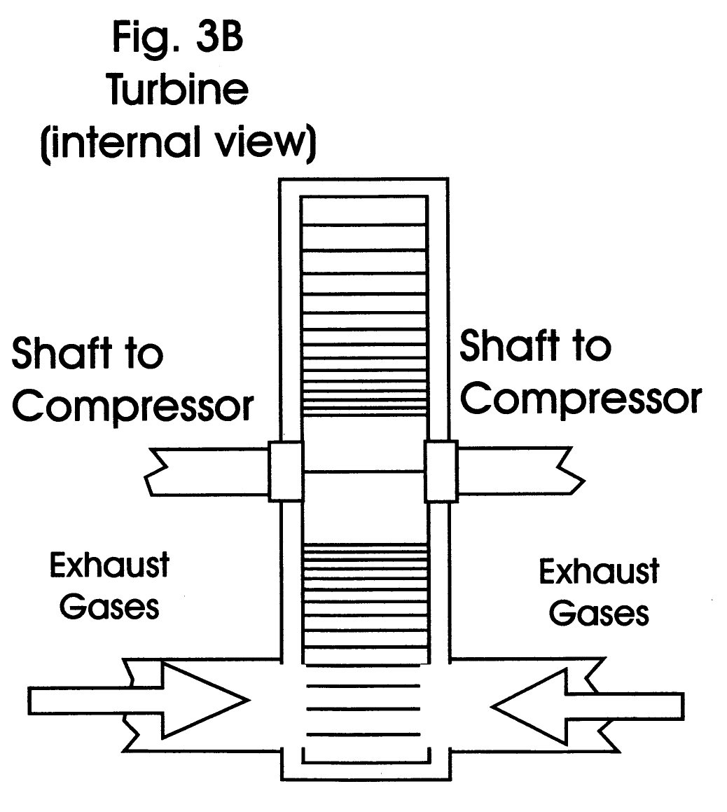

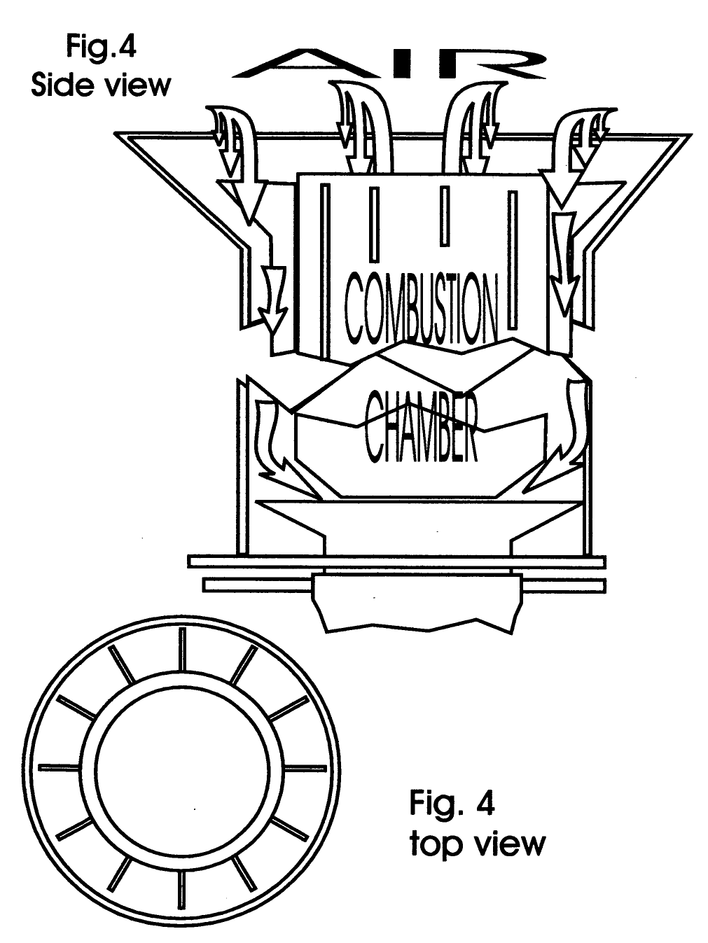

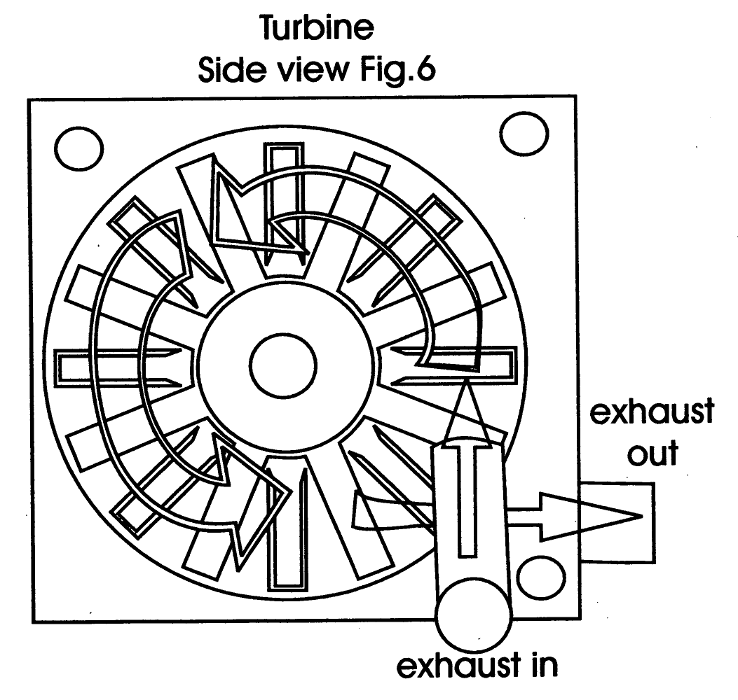

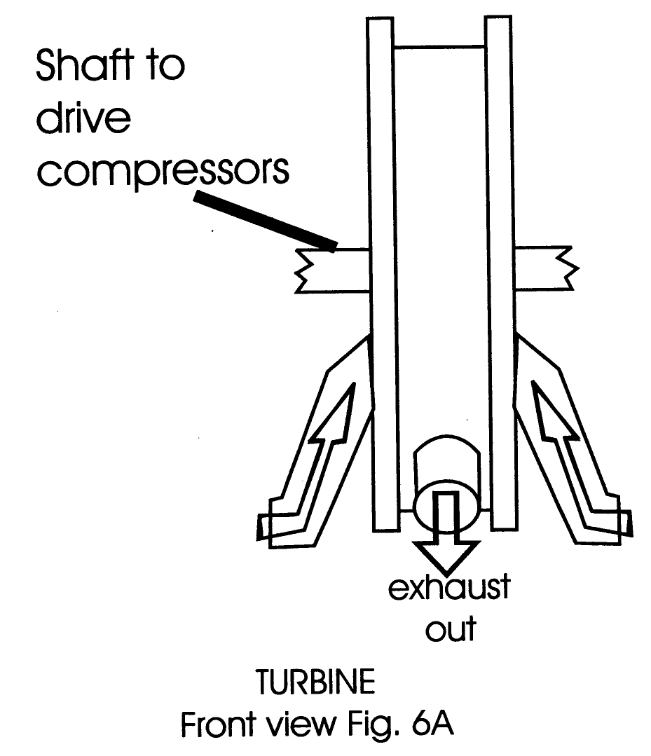

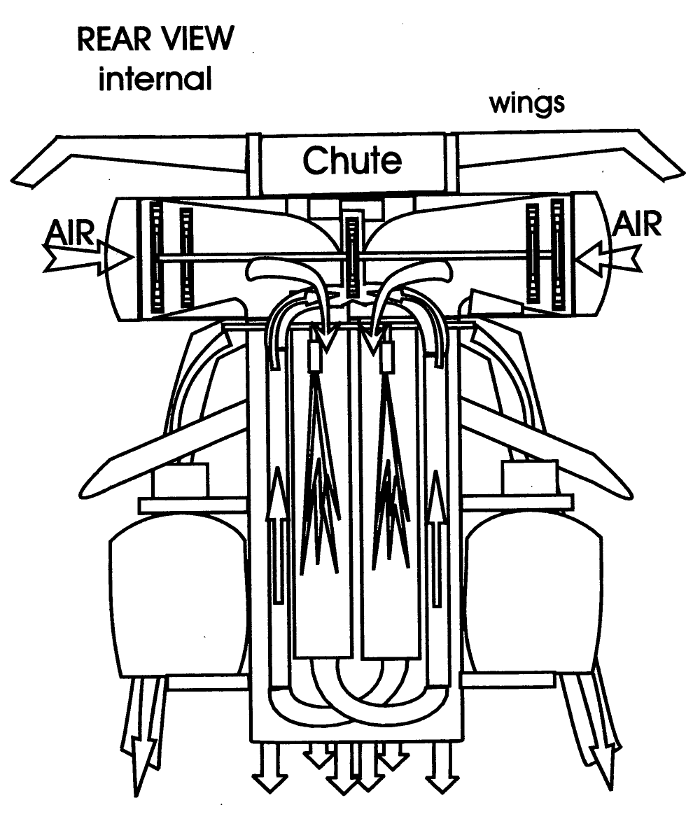

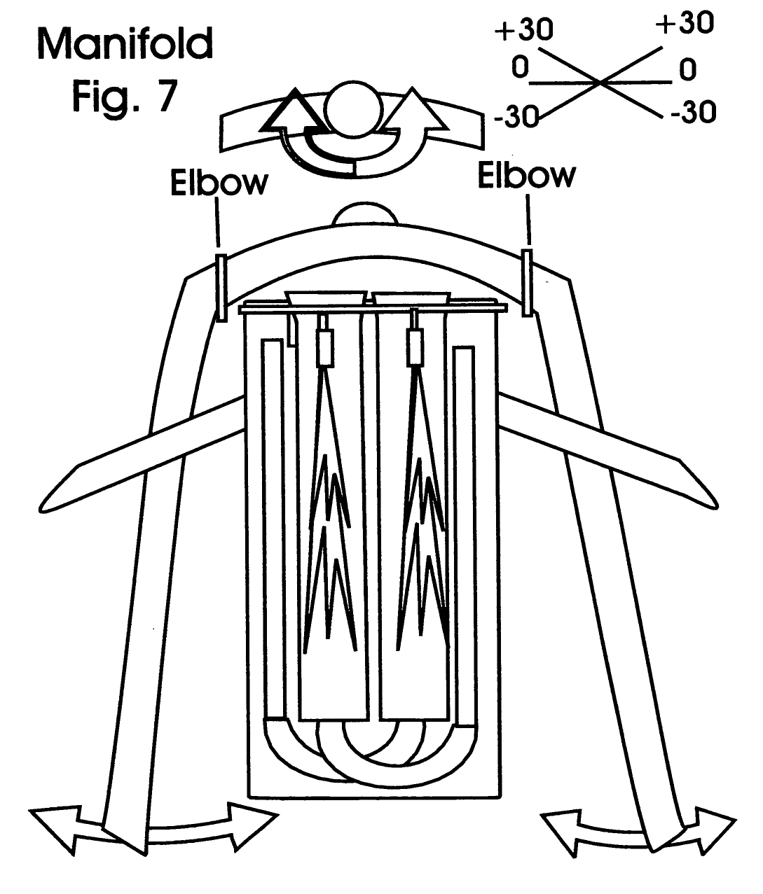

Inside the vertical unit are one or more combustion chambers pointing downward. Fuel (propane) is sprayed into the air stream of the combustion chamber and ignited using a small coil ignition system (see FIG. 3 &, 3A page 13). Some of the air forced into the vertical unit flows past the outside of the combustion chambers and out the bottom of the vertical unit to keep the chambers and piping cool and provide thrust for lift (see FIG. 3, page 13). The combustion chamber is double-walled (titanium internal chamber, stainless steel external) to allow air to pass through to a gap between the base of the inside chamber and the base of the outside chamber where it mixes with the burning fuel-air mixture to cool the flame as it enters the exhaust piping to the turbine (see FIG. 4, page 15). Air is also piped into the exhaust piping through air intake tubes from the intake housing (see FIG. 1, page 11). The tubes come in at the beginning of the exhaust piping (see FIG. 5, page 13). The exhaust gases are piped 180 degrees upward past one or more turbines connected by the common horizontal shaft to drive the compressors in the intake housing (see FIG. 6 & 6A, page 16 & 17).

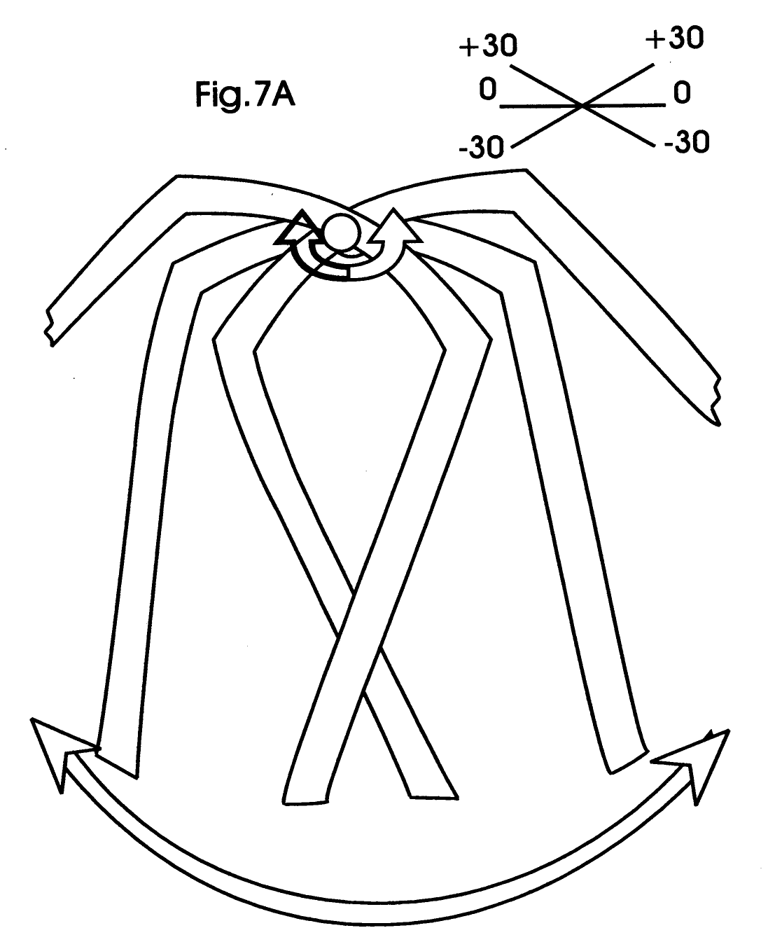

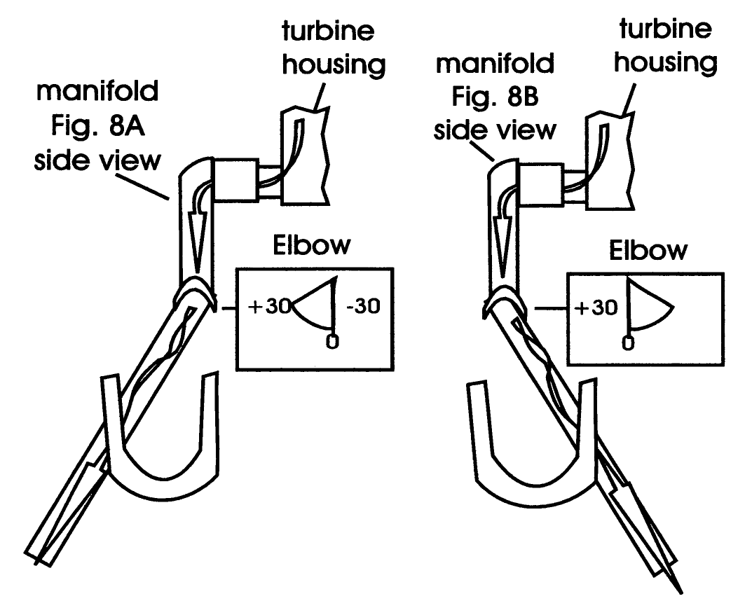

The exhaust gases are roughed into a common manifold, where it is divided equally and then pointed downward to provide thrust for lift. The manifold pivots on the outlet of the turbine housing, allowing it to rotate up to +30 degrees as well as −30 degrees for side to side flight (see FIG. 7 page 19 & FIG. 7A page 20). At the elbows the down pipes are jointed to allow for up to 30 degree forward as well as 30 degree rearward directing for forward flight, rearward flight, left pivoting and right pivoting turns (see FIGS. 8A, & 8B page 21).

Throttle is controlled by a motorcycle type twist control tied to a spring loaded valve in line with the fuel tank or tanks.

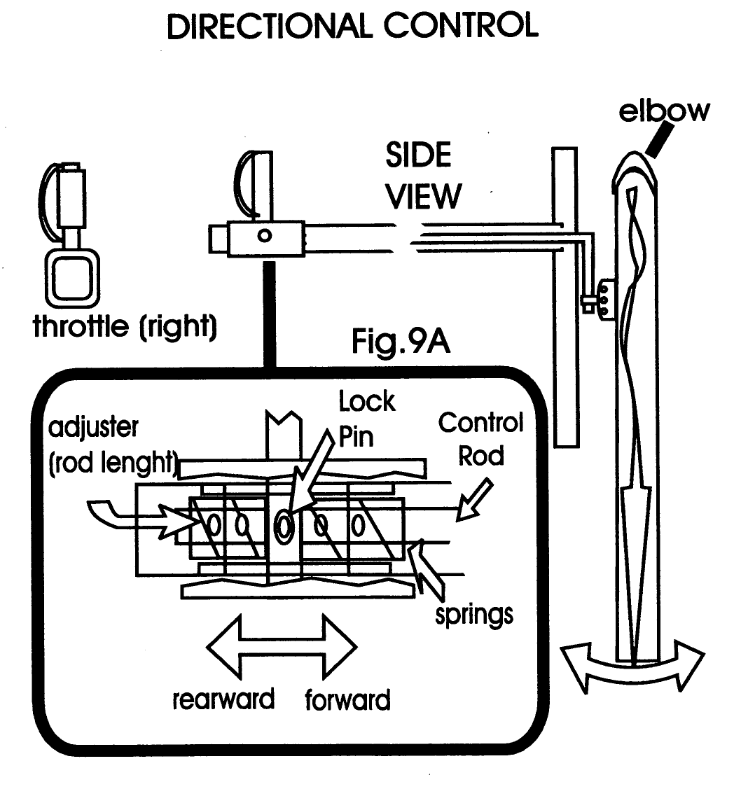

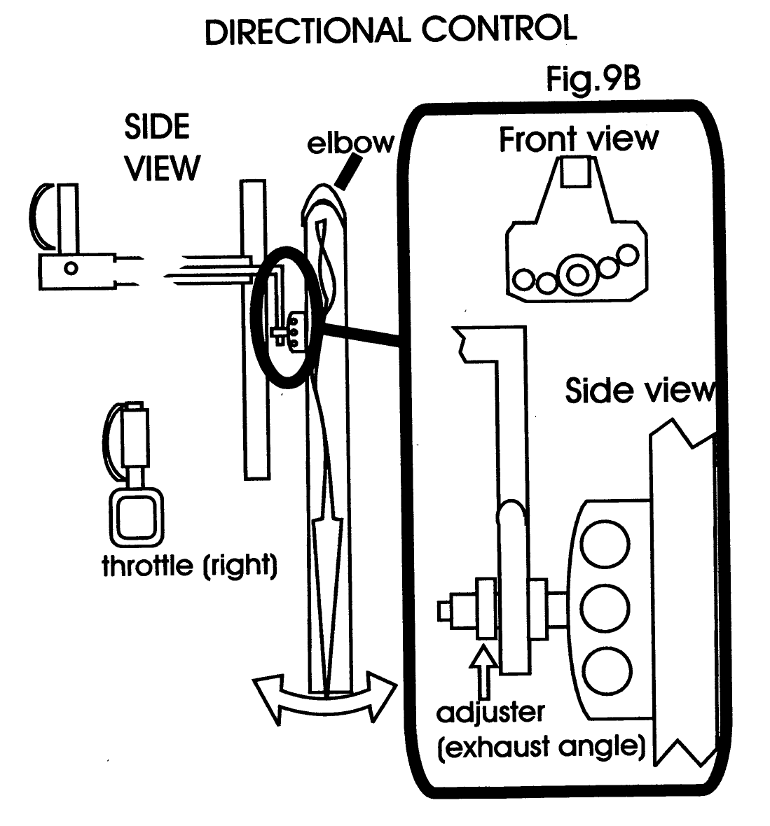

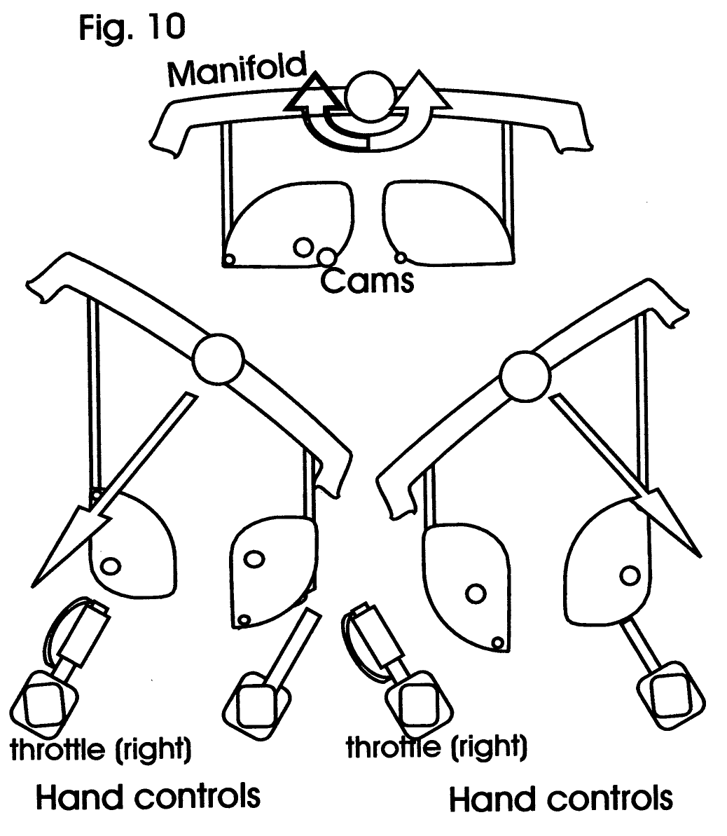

Directional controls are spring loaded adjustable rods linked to the exhaust piping. Push the hand grips away from or pull towards your body, to direct the exhaust flow forward and rearward (see FIG. 9 page 22). Leaning the hand grips left or right turns the manifold cams shown (see FIG. 10 page 24). The cams push and pull on linkage rods attached to the manifold tilting it. This directs the exhaust flow opposite the direction wanted, forcing the device to fly in the direction wanted (see FIG. 10, page 24). The intake openings feature air cups, they direct air into the intakes in forward flight (see page 27).

I believe that I am the only inventor of this item.

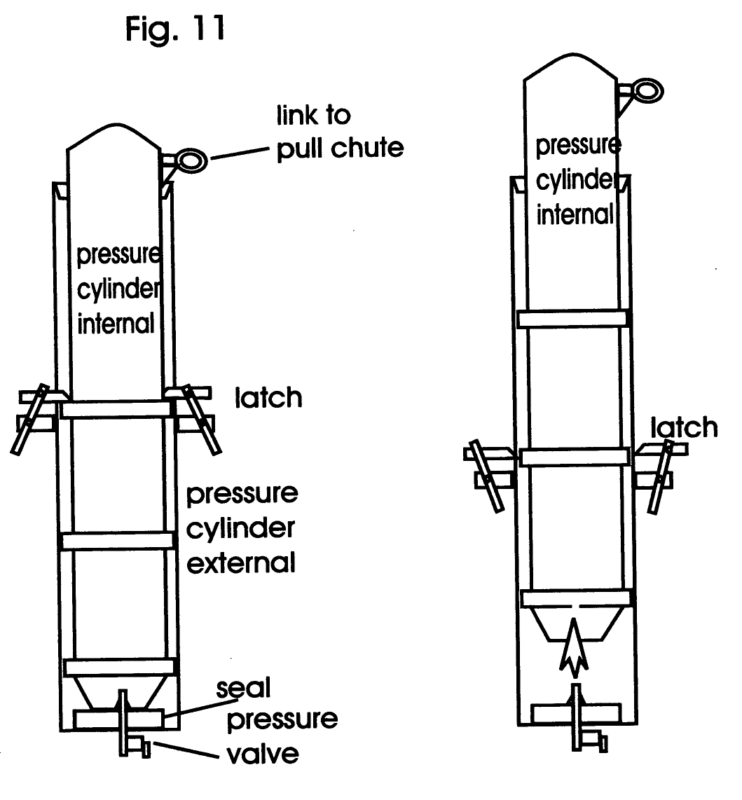

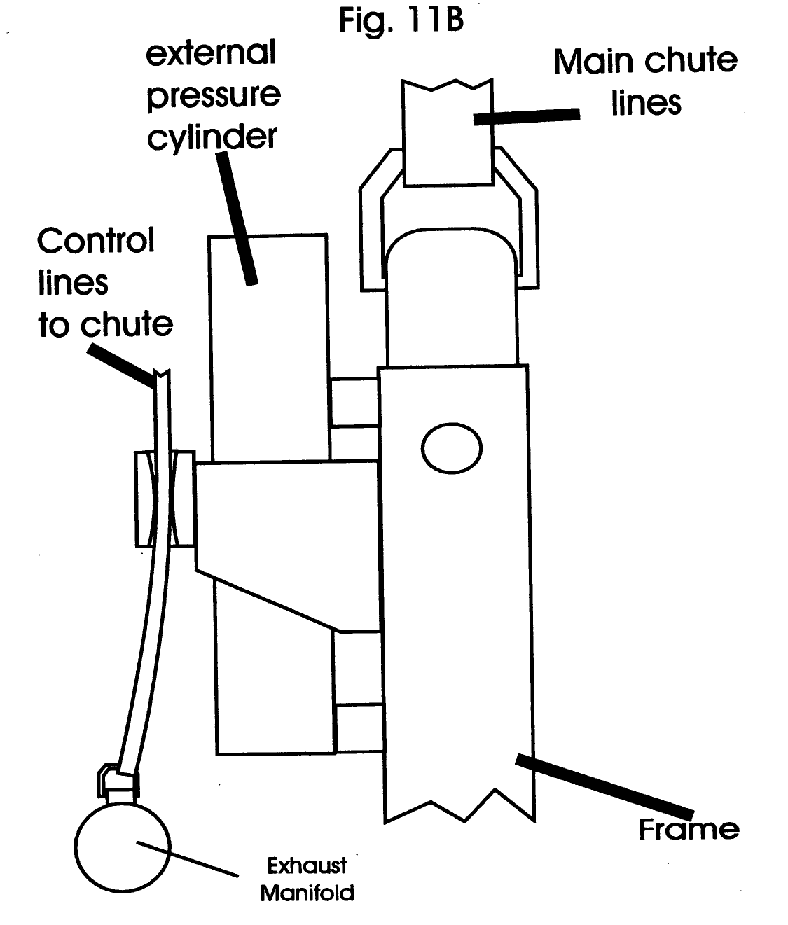

Attached to the vertical members of the mainframe are the external pressure cylinders for the ballistic safety chute (see FIG. 11, page 25). The external pressure cylinder has a valve in the bottom to add pressure. The internal pressure cylinder is held down to a seal in the bottom of the external cylinder by latches and is attached to the main chute by a pull cord. When the latch is pulled either manually or automatically, the pressure cylinder fires out the external cylinder, pulling the chute by the cord out of its housing. The chute is achnored to the frame. The control cords are attached to eather end of the top of the manifold and allows directional control of the chute using the normal controls for side to side flight (see FIG. 11B, page 25B). The pressure should be at least one-hundred pounds using ordinary air ( see FIG. 11, page 27).

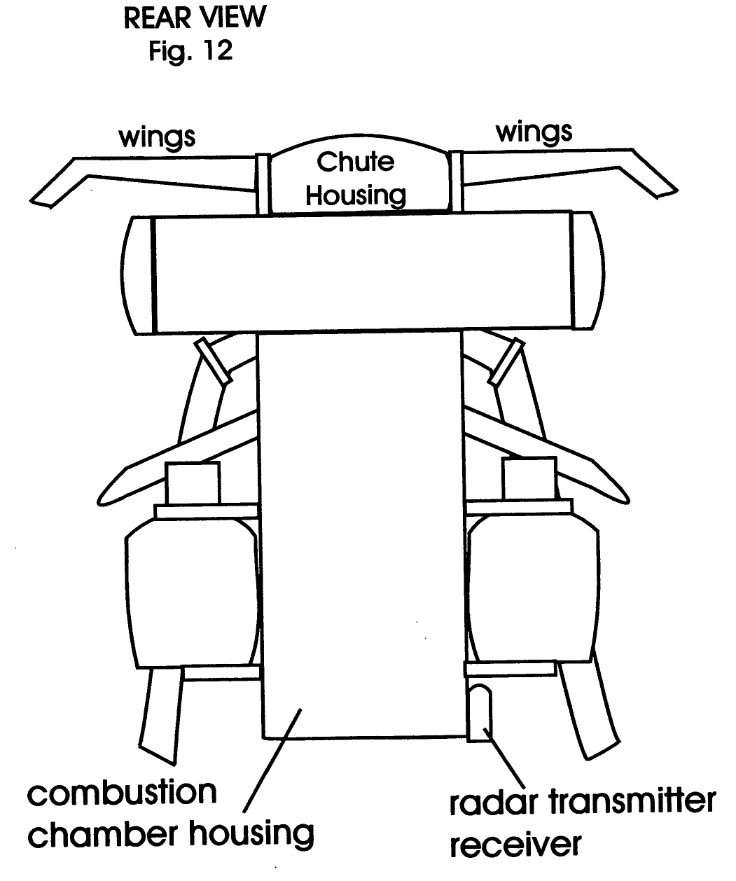

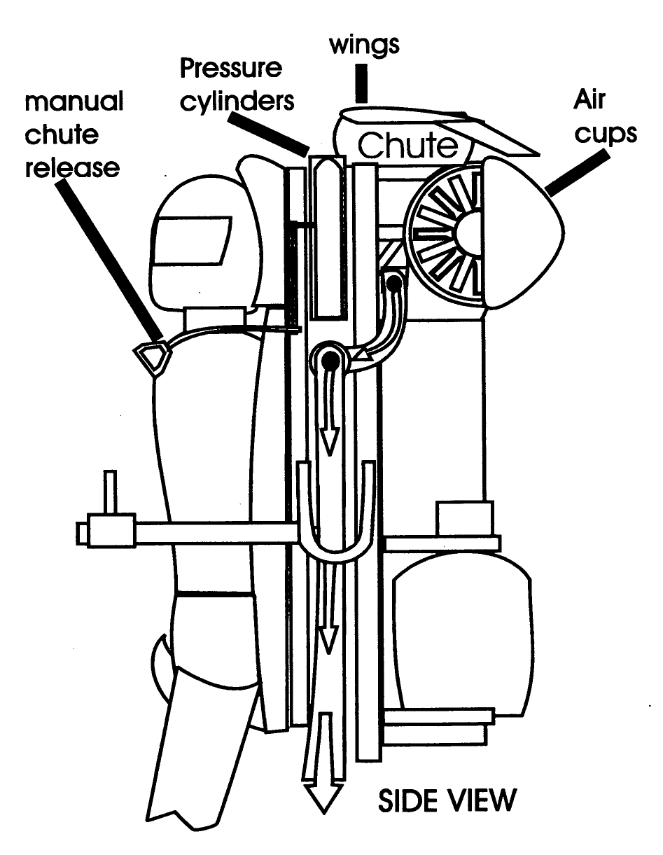

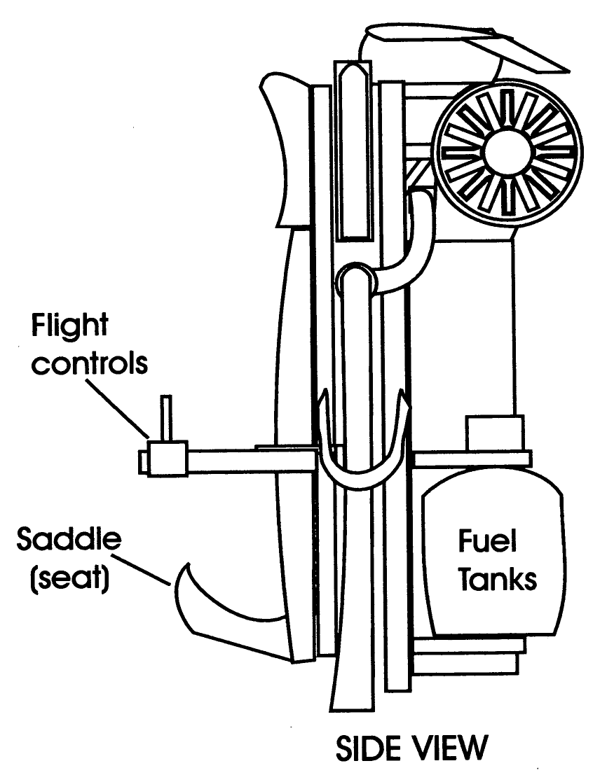

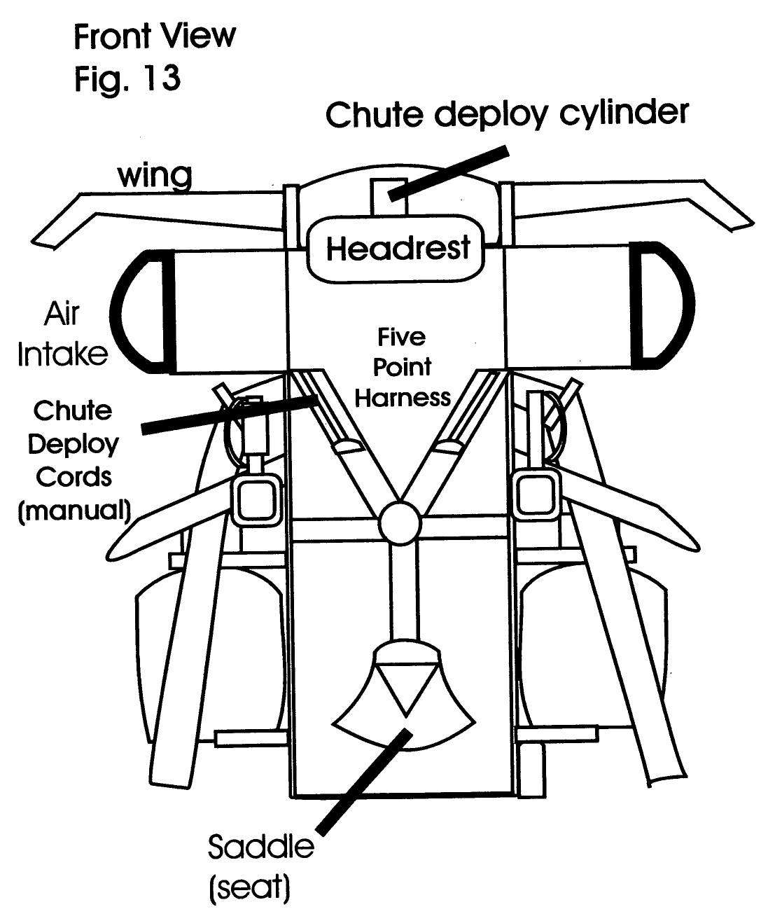

Attached to the frame on either side of the chute housing are small wings to add lift in forward motion (see FIG. 12, page 26). A small radar type transmission and receiver unit is attached to the bottom of the rear cover in the back, pointing downward (see FIG. 12, page 26). It is keyed to deploy the chute automaticly as a safety device if the rate of descent is too great, and in case of engine failure. The chute can also be deployed manually by pulling a chute deploy handle. (see FIG. 13, page 31)

1. The use of twin compressors, pulling air inward, at the opposite ends of the main shaft.

2. The use of a turbine and housing in the center of the main shaft.

3. A single turbine used to drive two separate compressor assemblies.

4. The cooling of the turbine from both sides. (Helps keep the temp. down, increasing turbine life.)

5. The use of a radar system to trigger a steerable safety chute when rate of decent becomes too great. (engine failure)

6. The use of both exhaust and compressor bypass in a personal flight vehicle for vertical thrust
